(19) United States
(12) Patent Application Publication
(10) Pub. No.: US 2013/0241747 A1
(43) Pub. Date: Sep. 19, 2013

(54) VEHICLE INFORMATION TRANSMITTING DEVICE

(71) Applicants: Yoshiyuki Hatakeyama, Fuji-shi (JP); Shinya Kawamata, Mishima-shi (JP)

(72) Inventors: Yoshiyuki Hatakeyama, Fuji-shi (JP); Shinya Kawamata, Mishima-shi (JP)

(73) Assignee: TOYOTA JIDOSHA KABUSHIKI KAISHA, Toyota-shi, Aichi (JP)

(21) Appl. No.: 13/989,887

(22) PCT Filed: Dec. 8, 2010
(86) PCT No.: PCT/JP2010/072042

§ 371 Date: May 28, 2013

(51) Int. Cl. B60Q 1/00

(52) U.S. Cl. CPC B60Q 1/00
USPC 340/901

(57) ABSTRACT

A subject is to provide a vehicle information transmitting device capable of more clearly transmitting information to a driver. In the present embodiment, a virtual image for attracting attention in which a variation amount per unit change of color or luminance is set small is appeared under a situation where a relative deceleration of an object, i.e. a preceding vehicle, is small and thus attention attracting is necessary. A virtual image for warning in which the variation per unit change of color or luminance is set large is appeared under a situation where the relative deceleration of the object is large and thus warning is necessary.

### FIELD

The present invention relates to a vehicle information transmitting device.

### BACKGROUND

Patent Literature 1 discloses an obstacle warning device of a vehicle that individually changes the size or luminance of right and left warning displays when detecting an obstacle on the right and left of the vehicle. Patent Literature 2 discloses a vehicle drive supporting system that notifies the driver of danger by irradiating light of a light source installed in the vehicle to a position on a front glass surface corresponding to the detected position of danger exterior to the vehicle as the light reflecting on the background of the front glass.

Other conventional art literatures include Patent Literatures 3 and 4. Patent Literature 3 discloses a vehicle head-up display that displays a radio wave condition even when a message is not coming in to appropriately make the driver conscious of the display when the incoming message is displayed. Patent Literature 4 discloses a vehicle display device that displays an image shifted in a curve direction at the time of travelling a curve.

### CITATION LIST

### Patent Literature

Patent Literature 1: Japanese Patent Application Laid-open No. 2000-172994
Patent Literature 2: Japanese Patent No. 3626229
Patent Literature 3: Japanese Patent Application Laid-open No. 2001-171390
Patent Literature 4: Japanese Patent Application Laid-open No. 2004-155307

### SUMMARY

### Technical Problem

However, Patent Literatures 1 and 2 have problems in that improvements can still be made in the manner of transmitting the quality of information such as extent of danger.

In light of the foregoing, it is an object of the present invention to provide a vehicle information transmitting device capable of more clearly transmitting the information to the driver.

### Solution to Problem

In a vehicle information transmitting device according to the present invention that transmits information in a mode involving changes, a variation amount of the mode per unit change is changed according to the information to be transmitted. In addition, it may be possible to configure that only the variation amount is changed within a certain time. Further, it may be possible to configure that the variation amount is larger as a priority of the information is higher. Further, it may be possible to configure that the variation amount is larger as a degree of danger is higher.

### Advantageous Effects of Invention

The present invention has an effect of more clearly transmitting the information to the driver by changing the variation amount of the mode per unit change according to the transmitting information when transmitting the information in a mode involving changes.

### BRIEF DESCRIPTION OF DRAWINGS

FIG. 1 is a block diagram illustrating an example of a configuration of a vehicle information transmitting system according to the present embodiment.

FIG. 2 is a view illustrating an example of a configuration of a light source panel 10.

FIG. 3 is a view illustrating an example of the configuration of the light source panel 10.

FIG. 4 is a view illustrating an example of the configuration of the light source panel 10.

FIG. 5 is a view illustrating an example of a mounting position of the light source panel 10.

FIG. 6 is a view illustrating an example of a definition of an eye point 30.

FIG. 7 is a view illustrating an example of the mounting position of the light source panel 10.

FIG. 8 is a view illustrating an example of the mounting position of the light source panel 10.

FIG. 9 is a view illustrating an example of the mounting position of the light source panel 10.

FIG. 10 is a view illustrating an example of a display range of a virtual image 31 when seen from the upper side of a vehicle 1.

FIG. 11 is a view illustrating an example of an adjusting method of color and luminance of light from a light source 10a.

FIG. 12 is a view illustrating an example of a map defining a relationship between a distance L and the color/luminance, and a map defining a relationship between an angle θ and the color/luminance.

FIG. 13 is a view illustrating an example of a map defining a relationship between a vehicle body color and regular-time color, attention attracting color, warning color, and luminance.

FIG. 14 is a view illustrating an example of a way of showing the virtual image 31.

FIG. 15 is a view illustrating an example of the way of showing the virtual image 31.

FIG. 16 is a view illustrating an example of the way of showing the virtual image 31.

FIG. 17 is a view illustrating an example of the way of showing the virtual image 31.

FIG. 18 is a view illustrating an example of the way of showing the virtual image 31.

FIG. 19 is a view illustrating an example of the way of showing the virtual image 31.

FIG. 20 is a view illustrating an example of the way of showing the virtual image 31.

FIG. 21 is a flowchart illustrating an example of a risk calculating operation and a lighting control operation executed by the vehicle information transmitting system according to the present embodiment.

FIG. 22 is a view illustrating an example of a map defining a relationship between a position of an object along with a degree of danger and an irradiation position along with an irradiation area of the light.

FIG. 23 is a view illustrating an example of a relationship between the degree of danger and a variation amount per unit change of the color/luminance of the light.

FIG. 24 is a view illustrating an example of a way of showing the virtual image 31.

FIG. 25 is a view illustrating an example of the way of showing the virtual image 31.

FIG. 26 is a view illustrating an example of the way of showing the virtual image 31.

FIG. 27 is a view illustrating an example of the way of showing the virtual image 31.

FIG. 28 is a view illustrating an example of the way of showing the virtual image 31.

FIG. 29 is a view illustrating an example of the way of showing the virtual image 31.

FIG. 30 is a view illustrating an example of the way of showing the virtual image 31.

### DESCRIPTION OF EMBODIMENTS

An embodiment of a vehicle information transmitting system including a vehicle information transmitting device according to the present invention will be hereinafter described in detail based on the drawings. The present invention is not limited by such embodiment.

The vehicle information transmitting system according to the present embodiment is a system that irradiates a front window glass with light from a plurality of light sources (LED: Light-Emitting Diode) mounted (arrayed) in an array form (plural rows or plural columns) on an instrument panel to notify (attract attention or warn) the driver of an existing position or an existing direction of a dangerous object (e.g., pedestrian, bicycle, automobile, blind angle, etc.) at around the own vehicle using a virtual image from the light. An example of the configuration of such system, the operation executed by such system, and the like will be hereinafter described in detail with reference to the drawings.

Hereinafter, a mounting position of the light source will be described mainly as the instrument panel, but may be a meter panel, for example. Furthermore, the light source will be described mainly as a single-color LED, but may be a full color LED, a valve, or the like, for example. The irradiating destination of the light (displaying destination of the virtual image) will be described mainly as the front window glass, but may be an A-pillar, a side mirror, a meter panel, an instrument panel, or the like, for example. What is to be notified to the driver will be described mainly as a dangerous object (risk), but may be routing assistance, mail reception, state and condition of the driver (e.g., awake, sleeping, etc.), state of the own vehicle (e.g., state of economical driving, etc.), and the like, for example. A means for detecting the dangerous object will be described as an object sensor, but may be image recognition by camera, communication such as vehicle-vehicle communication or road-vehicle communication, navigation information (e.g., map and database associated with a dangerous place), and the like, for example. The position and direction of prompting the notification will be described mainly as right and left when seen from the driver, but may be front and back when seen from the driver, for example. The displaying shape of the virtual image will be described mainly as a linear shape (dot sequence), but may be a figure such as an icon, character, symbol, or the like, for example. Other than notifying the existing position or the existing direction of the dangerous object, description of the dangerous object (e.g., dangerous object is a pedestrian, bicycle, automobile, blind angle, etc.) may be notified. The mode of notification (form of notification, manner of notification) will be described mainly as light, but may be a different mode as far as it can be perceive by humans, such as sound (voice) or operation reaction force, and the like, for example.

### 1. Configuration

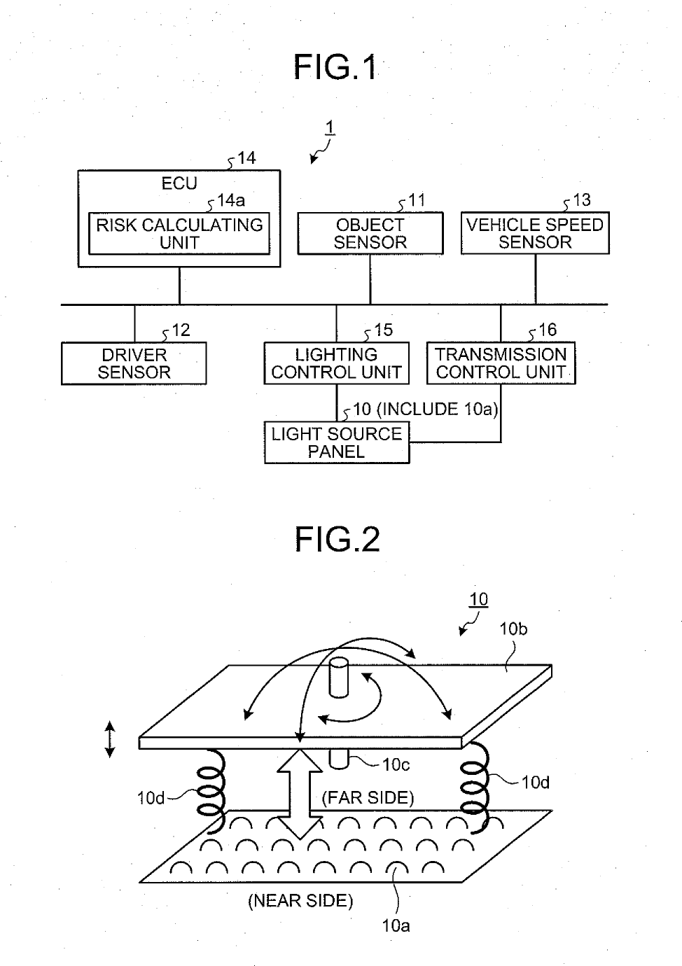

FIG. 1 is a block diagram illustrating an example of a configuration of a vehicle information transmitting system according to the present embodiment. A vehicle 1 includes a light source panel 10 having a plurality of light sources 10a and a mechanism for adjusting the transmitting extent of the light (specifically, luminance of the light) from the light sources 10a, an object sensor 11, a driver sensor 12, a vehicle speed sensor 13, an ECU (Electronic Control Unit) 14 having a risk calculating unit 14a, a lighting control unit 15, and a transmission control unit 16.

The object sensor 11 detects a vehicle exterior environment surrounding the vehicle 1 (e.g., objects such as pedestrian, bicycle, automobile, blind angle (e.g., behind a building, far side of curve, far end of vehicle etc.), information associated with a road shape such as linear, left curve, and right curve). The driver sensor 12 detects an observing point or an observing direction. The vehicle speed sensor 13 detects the vehicle speed of the vehicle 1. The risk calculating unit 14a calculates (estimates) the degree of danger (risk) around the vehicle 1 based on the vehicle exterior environment surrounding the vehicle 1 detected by the object sensor 11, the observing point or observing direction detected by the driver sensor 12, the vehicle speed detected by the vehicle speed sensor 13, and the like.

FIG. 2 is a view illustrating an example of a configuration of the light source panel 10. In FIG. 2, reference sign 10b is assigned to a diffusion plate, reference sign 10c to a shaft member, and reference sign 10d to a spring. In the light source panel 10, the plurality of light sources 10a are arranged in an array form of plural columns or plural rows so that light can be irradiated in the horizontal direction (right and left direction) and the vertical direction (height direction, up and down direction). In order to have a virtual image in three horizontal rows of red, yellow, and green to appear in order from the top on the front window glass, the light source 10a that emits a red light is arranged in the row on the near side when seen from the driver when the light source panel 10 is installed, the light source 10a that emits an yellow light is arranged in the middle row, and the light source 10a that emits a green light is arranged in the row on the far side. The light source panel 10 is arranged with the diffusion plate 10b and the shaft member 10c for entirely or partially adjusting the transmitting extent of the light (blurring extent of the light/diffuseness of the light) from the light source 10a in association with the position of the light source 10a, and a plurality of springs 10d that plays the role of a fail safe for maintaining the distance between the light source 10a and the diffusion plate 10b in a maximum state at the time of malfunction. The light source panel 10 is also arranged with a power device (not illustrated) such as a motor that electromagnetically or electrically achieves three rotational movements of pitch, yaw, and roll of the diffusion plate 10b. The diffusion plate 10b is a thin plate-like member made from a material such as polypropylene or polycarbonate, for example. The shaft member 10c is a rod-like member that serves as a shaft of the three rotational movements of the diffusion plate 10b. The positions or the number of springs 10d may be any positions or the number that can maintain the distance between the light source 10a and the diffusion plate 10b in a maximum state at the time of malfunction. A flannel lens may be inserted above or below the diffusion plate 10b to enlarge the light to a wider range.

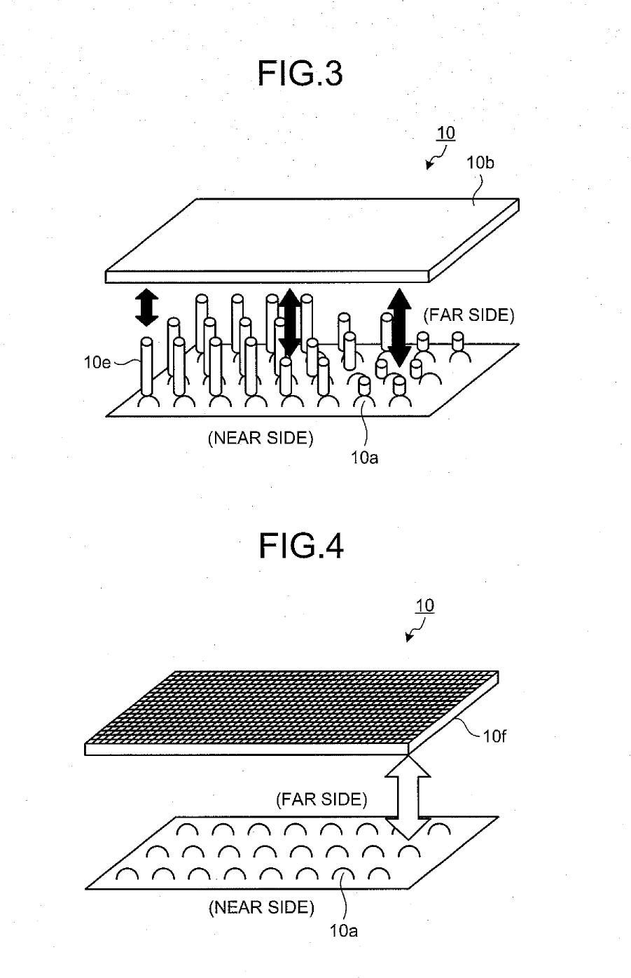

FIG. 3 is a view illustrating another example of the configuration of the light source panel 10. In FIG. 10, reference sign 10e is assigned to a light guiding member. The light source panel 10 is arranged with the diffusion plate 10b and the light guiding member 10e for adjusting the transmitting extent of the light from the light source 10a. The light guiding member 10e is an optical fiber, for example, and is arranged with respect to the individual light source 10a as illustrated in the figure. The light source panel 10 is arranged with a power device (not illustrated) for achieving the adjustment of the distance between the diffusion plate 10b and the light guiding member 10e. The transmitting extent of the light can be adjusted independently for each light source lea by adopting the configuration illustrated in FIG. 3.

FIG. 4 is a view illustrating another example of the configuration of the light source panel 10. In FIG. 4, reference sign 10f is assigned to a liquid crystal panel. The light source panel 10 is arranged with the liquid crystal panel 10f for adjusting the transmitting extent of the light from the light source 10a in a state where the distance from the light source 10a is fixed. An aperture ratio of the liquid crystal panel 10f reduces from the center towards the periphery to gradate the light by adopting the configuration illustrated in. FIG. 4.

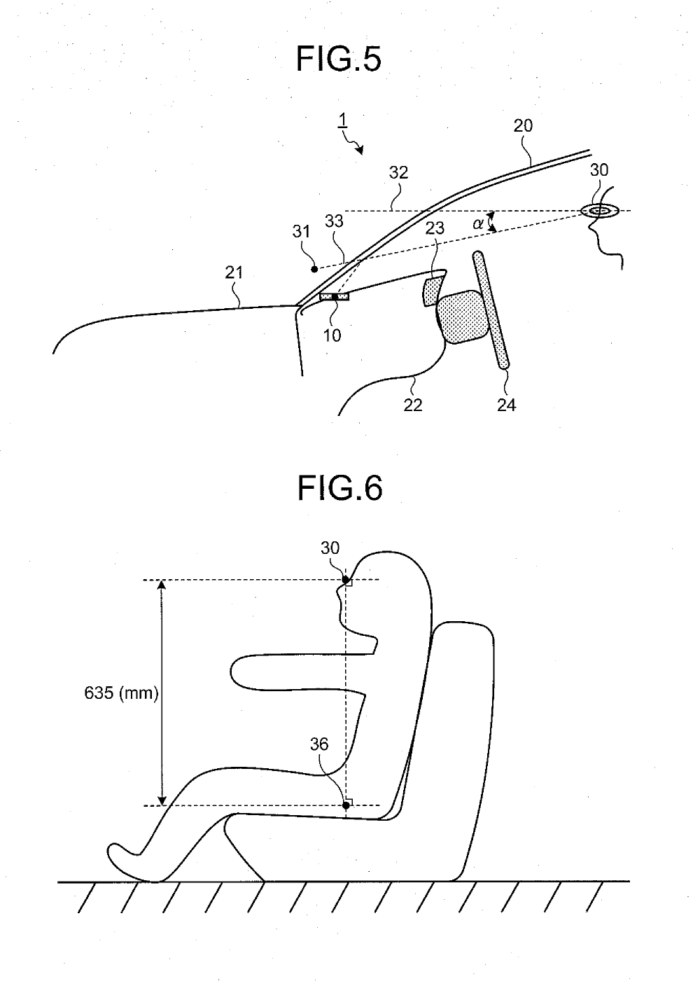

FIG. 5 is a view illustrating an example of a mounting position of the light source panel 10 in the vehicle 1. In FIG. 5, reference sign 20 is assigned to a front window glass having a double reflection suppressing mechanism such as a tapered glass, for example, reference sign 21 to a bonnet, reference sign 22 to an instrument panel, reference sign 23 to a meter panel, reference sign 24 to a steering wheel, reference sign 30 to an eye point of the driver, reference sign 31 to a virtual image by the light from the light source panel 10, reference sign 32 to a horizontal line passing the eye point 30, and reference sign 33 to an optical path of the light from the light source panel 10. The light source panel 10 is installed on the instrument panel 22, in particular, at a position where the virtual image 31 can be perceived by the driver at a lowermost layer of the peripheral viewing field of the driver e.g., depression angle α from the horizontal line 32 passing the eye point 30 is smaller than or equal to five degrees). For example, the light source panel 10 is installed at a position closer to the front window glass 20 side than to the meter panel 23 (i.e., far side of the instrument panel 22 when seen from the eye point 30). As illustrated in FIG. 6, the eye point 30 is a point that is 635 (mm) above, in the vertical direction, a seating reference point 36. The seating reference point 36 is a hip joint point of a human phantom when it is seated on a seat, based on ISO 6549-1980 (see “Notice defining items of safety standard of road trucking vehicle [2005.11.09] Annex 81 (Technical standard for front under mirror) disclosed on the website http://www.mlit.go.jp/jidosha/kijyun/saimokubetten/saibet_{—}0 81_{—}00.pdf”.

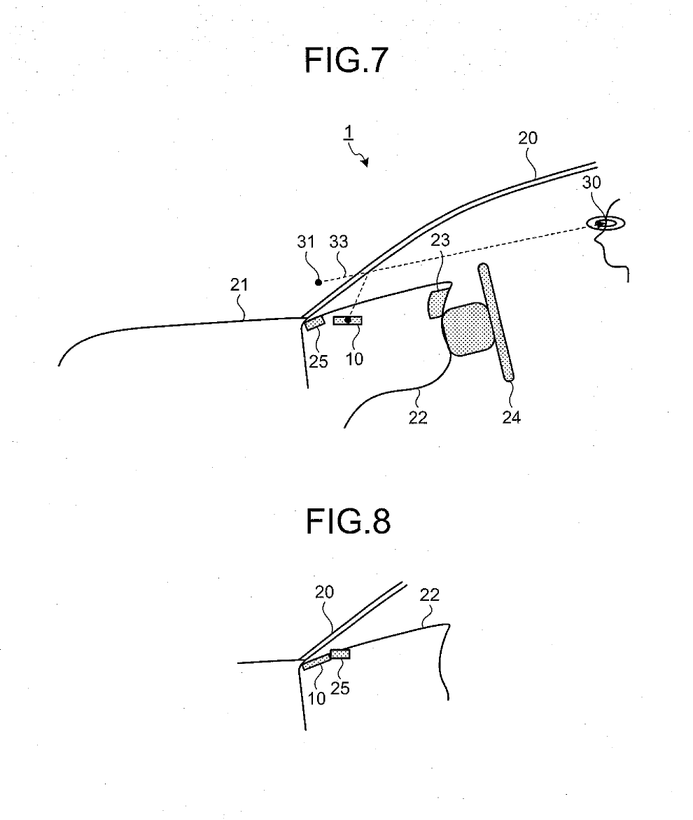

FIGS. 7 and 8 are views illustrating another example of the mounting position of the light source panel 10 in the vehicle 1. In FIGS. 7 and 8, reference sign 25 is assigned to a defroster blowing unit. For example, the light source panel 10 is installed at a position on the near side (see FIG. 7) or the far side (see FIG. 8) of the defroster blowing unit 25 when seen from the eye point 30. For example, the light source panel 10 is installed on the lower side than the surface of the instrument panel 22 (i.e., inside the instrument panel 22). For example, the light source panel 10 is embedded in the instrument panel 22.

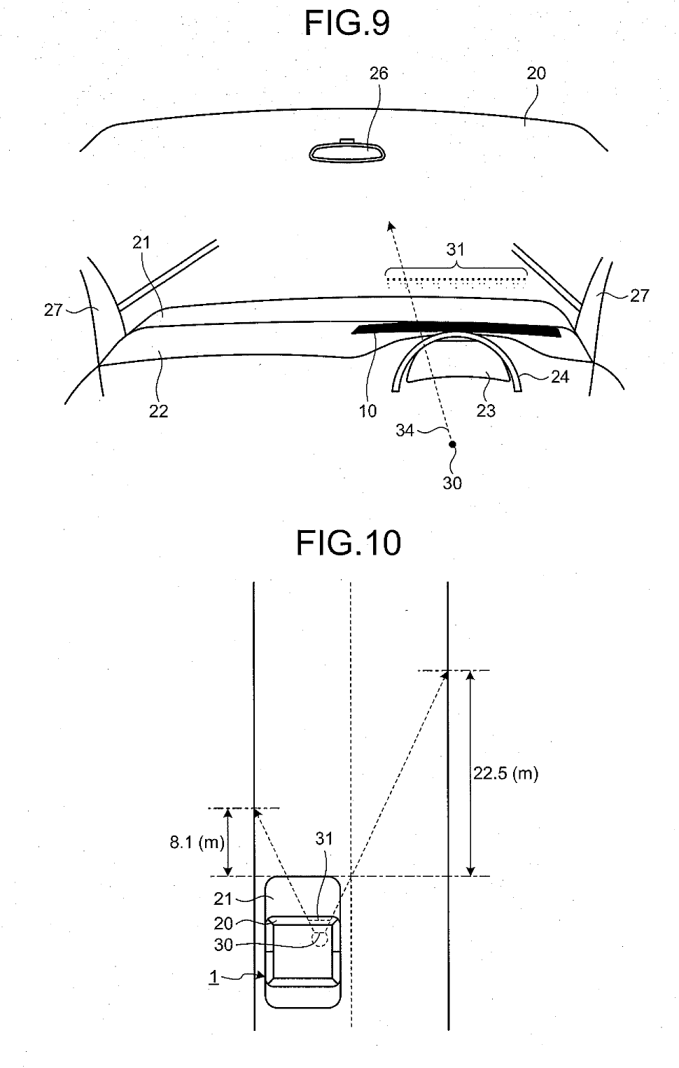

FIG. 9 is a view illustrating another example of the mounting position of the light source panel 10 in the vehicle 1. In FIG. 9, reference sign 26 is assigned to a rearview mirror, reference sign 27 to an A-pillar, and reference sign 34 to an observing direction of the driver. For example, the light source panel 10 is installed at a position substantially in front of the driver in the instrument panel 22. The light source panel 10 is installed on the instrument panel 22 such that the background of the virtual image 31 is the foreground (e.g., road, preceding vehicle, or the like), for example, when seen from the eye point 30.

FIG. 10 is a view illustrating an example of a display range of the virtual image 31 when seen from the upper side of the vehicle 1. If the vehicle 1, in which the light source panel 10 is mounted on the instrument panel 22 as illustrated above, is present on the road having a sidewalk width of 1 (m) and a lane width of 3.2 (m), for example, the display range of the virtual image 31 (range of the dangerous object) when seen from the eye point 30 is the illustrated range of 8.1 (m) on the left side and 22.5 (m) on the right side.

Returning back to FIG. 1, the lighting control unit 15 generates lighting patterns (e.g., lighting content or lighting mode associated with irradiation position of light in the front window glass 20, irradiation area of the light in the front window glass 20, color of the light, luminance of the light, cycle (blinking) of the light emission, variation per unit change of color or luminance of light (variation per unit of color or luminance), and the like) for regular-time, for attracting attention, or for warning, based on the vehicle exterior environment surrounding the vehicle 1 detected by the object sensor 11, the observing point or the observing direction of the driver detected by the driver sensor 12, the vehicle speed of the vehicle 1 detected by the vehicle speed sensor 13, the degree of danger around the vehicle 1 calculated with the risk calculating unit 14a, and the like, and executes the lighting control (e.g., adjustment of application voltage, etc.) of the individual light source 10a so as to obtain the generated lighting patterns.

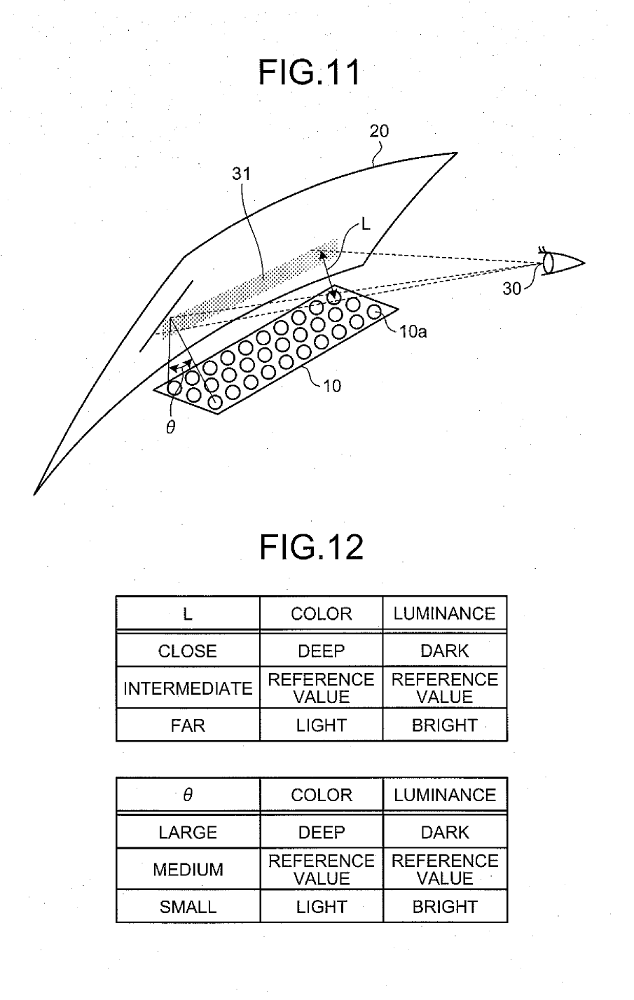

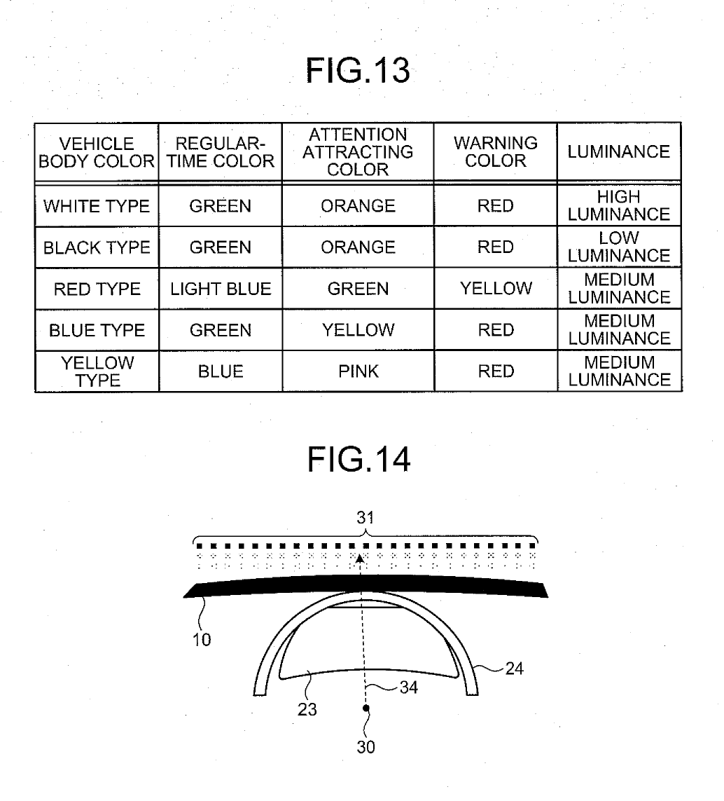

An example of a method for adjusting (calibrating) the color and the luminance of the light from the light source 10a will be described with reference to FIGS. 11 to 13. As illustrated in FIG. 11, the color and the luminance of the individual light source 10a are adjusted according to the distance L and/or the angle θ in advance. For example, the color and the luminance of the individual light source 10a are adjusted based on a map (see FIG. 12) defining a relationship between the distance L and the color/luminance, and/or a map (see FIG. 12) defining a relationship between the angle θ and the color/luminance. The distance L is the distance from the light source 10a to the irradiation position of the light of the light source 10a in the front window glass 20. The angle θ is the angle formed by a line segment connecting the arrangement position of the light source 10a and the irradiation position of the light, and the front window glass 20. The color and the luminance of the individual light source 10a in the regular-time, at the time of attracting attention, and at the time of warning are adjusted in advance, for example, according to the color of the instrument panel, the A-pillar, the side mirror, or the like. For example, the color and the luminance of the individual light source 10a in regular-time, at the time of attracting attention, and at the time of warning are adjusted based on a map (see FIG. 13) defining a relationship between a vehicle body color, and the regular-time color, attention attracting color, warning color, and luminance. The state of adjustment associated with the color and the luminance is stored in a storage region of the lighting control unit 15.

The lighting control unit 15 may adjust the luminance or the color of the light by turning on/off the headlight, using Conlight sensor, or the like. For example, the lighting control unit 15 may lower the luminance of the light at nighttime. The lighting control unit 15 may adjust the luminance, the color, the cycle (blinking) of the light emission, and the like according to the magnitude of reliability of the degree of danger estimated with the risk calculating unit 14a. The lighting control unit 15 may stop the light perceive by the driver of the illuminated lights, or may reduce the luminance/color, and the like of the light based on the observing point or the observing direction of the driver detected by the driver sensor 12. The lighting control unit 15 may also notify the content (e.g., whether the dangerous object is person, vehicle, etc.) of the dangerous object in accordance with the existing position or the existing direction of the dangerous object.

Returning back to FIG. 1, the transmission control unit 16 adjusts the transmitting extent (blurring extent/diffusiveness) of the light from the light source 10a in the light source panel 10 based on the vehicle exterior environment surrounding the vehicle 1 detected by the object sensor 11, the observing point or the observing direction of the driver detected by the driver sensor 12, the vehicle speed of the vehicle 1 detected by the vehicle speed sensor 13, the degree of danger around the vehicle 1 calculated by the risk calculating unit 14, the lighting pattern generated by the lighting control unit 15, and the like.

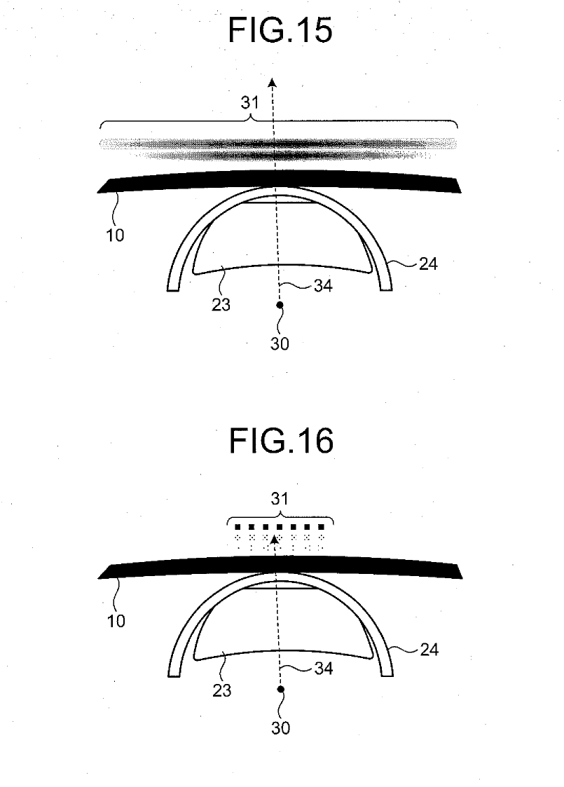

For example, when the lighting control unit 15 lights the light source 10a in the lighting pattern for attracting attention, the transmission control unit 16 makes the distance between the light source 10a and the diffusion plate 10b long overall when the light source panel 10 illustrated in FIG. 2 is used, makes the distance between the diffusion plate 10b and the light guiding member 10e long overall when the light source panel 10 illustrated in FIG. 3 is used, and reduces the aperture ratio of the liquid crystal panel 10f overall when the light source panel 10 illustrated in FIG. 4 is used. The virtual image 31 thus can be changed from a clear state illustrated in FIG. 14, to a dim blurred state illustrated in FIG. 15. That is, the virtual image 31 can be gradated.

The transmission control unit 16 adjusts the distance between the light source 10a and the diffusion plate 10b when the light source panel 10 illustrated in FIG. 2 is used, the distance between the diffusion plate 10b and the light guiding member 10e when the light source panel 10 illustrated in FIG. 3 is used, and the aperture ratio of the liquid crystal panel 10f when the light source panel 10 illustrated in FIG. 4 is used according to the degree of danger calculated by the risk calculating unit 14a. When the degree of danger is small, the transmission control unit 16 makes the distance between the light source 10a and the diffusion plate 10b long overall, makes the distance between the diffusion plate 10b and the light guiding member 10e long overall, and reduces the aperture ratio overall. When the degree of danger is large, the transmission control unit 16 makes the distance between the light source 10a and the diffusion plate 10b short overall, makes the distance between the diffusion plate 10b and the light guiding member 10e short overall, and increases the aperture ratio overall. Thus, the virtual image 31 can be appeared in a clear state when the risk is high, and the virtual image 31 can be appeared in a dim blurred state when the risk is low.

In a case where the lighting control unit 15 lights the light source 10a in the lighting pattern displaying specific information (e.g., character, icon, etc.), the transmission control unit 16 makes the distance between the light source 10a and the diffusion plate 10b short overall when the light source panel 10 illustrated in FIG. 2 is used, makes the distance between the diffusion plate 10b and the light guiding member 10e short overall when the light source panel 10 illustrated in FIG. 3 is used, and increases the aperture ratio of the liquid crystal panel 10f overall when the light source panel 10 illustrated in FIG. 4 is used. The virtual image 31 corresponding to the specific information thus can be appeared in a clear state.

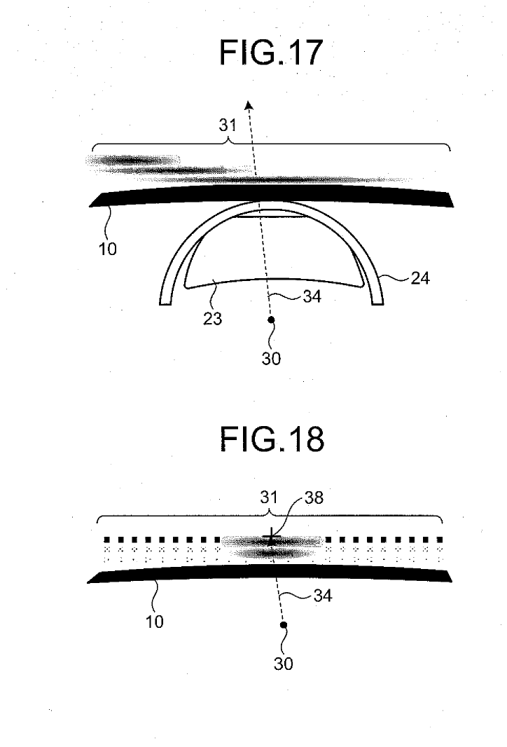

The transmission control unit 16 adjusts the distance between the light source 10a and the diffusion plate 10b when the light source panel 10 illustrated in FIG. 2 is used, the distance between the diffusion plate 10b and the light guiding member 10e when the light source panel 10 illustrated in FIG. 3 is used, and the aperture ratio of the liquid crystal panel 10f when the light source panel 10 illustrated in FIG. 4 is used according to the vehicle speed of the vehicle 1 detected by the vehicle speed sensor 13. The transmission control unit 16 makes the distance between the light source 10a and the diffusion plate 10b short overall, makes the distance between the diffusion plate 10b and the light guiding member 10e short overall, and increases the aperture ratio overall when the vehicle speed is smaller than or equal to a predetermined value (e.g., when the vehicle 1 is stopping, etc). When the vehicle speed is greater than the predetermined value (e.g., when the vehicle 1 is travelling, etc.), the transmission control unit 16 makes the distance between the light source 10a and the diffusion plate 10b long overall, makes the distance between the diffusion plate 10b and the light guiding member 10e long overall, and reduces the aperture ratio overall. Thus, the virtual image 31 can be appeared in a clear state as illustrated in FIG. 16 when the vehicle 1 is stopping, and the virtual image 31 can be appeared in a dim blurred state as illustrated in FIG. 17 when the vehicle 1 is travelling.

When the light source panel 10 illustrated in FIG. 2 is used, the transmission control unit 16 makes the distance from the light source 10a partially long by a portion corresponding to the arrangement position of the light source 10a that irradiates the light to the vicinity of a observing point 38 of the driver detected with the driver sensor 12 in the diffusion plate 10b. When the light source panel 10 illustrated in FIG. 3 is used, the transmission control unit 16 makes the distance from the diffusion plate 10b partially long by the light guiding member 10e arranged in the light source 10a that irradiates the light to the vicinity of the observing point 38. When the light source panel 10 illustrated in FIG. 4 is used, the transmission control unit 16 reduces the aperture ratio by the portion corresponding to the arrangement position of the light source 10a that irradiates the light to the vicinity of the observing point 38 in the liquid crystal panel 10f. Thus, as illustrated in FIG. 18, only the portion (portion in the vicinity of the observing point 38) seen from the driver of the virtual image 31 can be selectively appeared in the dim blurred state.

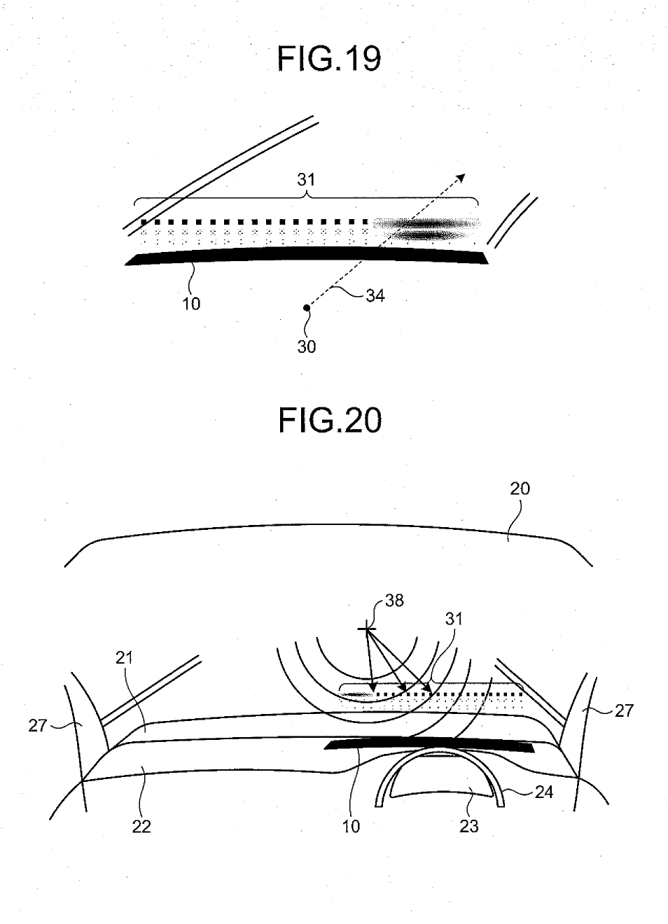

The transmission control unit 16 also adjusts the transmitting extent of the light from the light source 10a in the light source panel 10 according to the road shape such as left curve, right curve, and the like. When the light source panel 10 illustrated in FIG. 2 is used, the transmission control unit 16 makes the distance from the light source 10a partially long by the portion corresponding to the arrangement position of the light source 10a that irradiates the light in the changing direction of the road shape (e.g., right direction for right curve, left direction for left curve) observed by the driver in the diffusion plate 10b. When the light source panel 10 illustrated in FIG. 3 is used, the transmission control unit 16 makes the distance from the diffusion plate 10b partially long by the light guiding member 10e arranged in the light source 10a that irradiates the light in the changing direction of the road shape. When the light source panel 10 illustrated in FIG. 4 is used, the transmission control unit 16 reduces the aperture ratio by the portion corresponding to the arrangement position of the light source 10a that irradiates the light in the changing direction of the road shape in the liquid crystal panel 10f. Thus, as illustrated in FIG. 19, only the portion in the curve direction observed by the driver (portion in the vicinity of the observing direction 34) of the virtual image 31 can be selectively appeared in the dim blurred state.

The transmission control unit 16 also adjusts the transmitting extent of the light from the light source 10a in the light source panel 10 according to the distance from a central viewing field of the driver (observing point 38 of the driver detected with the driver sensor 12) to the virtual image 31. When the light source panel 10 illustrated in FIG. 2 is used, the transmission control unit 16 makes the distance between the light source 10a, in which the distance from the observing point 38 is relatively short, and the diffusion plate 10b relatively long, makes the distance from the light source 10a, which distance from the observing point 38 is relatively long, and the diffusion plate 10b relatively short, and makes the distance between the light source 10a, which distance from the observing point 38 is a relatively intermediate distance, and the diffusion plate 10b relatively intermediate. When the light source panel 10 illustrated in FIG. 3 is used, the transmission control unit 16 makes the distance between the light guiding member 10e arranged in the light source 10a, which distance from the observing point 38 is relatively short, and the diffusion plate 10b relatively long, makes the distance between the light guiding member 10e arranged in the light source 10a, which distance from the observing point 38 is relatively long, and the diffusion plate 10b relatively short, and the distance between the light guiding member 10e arranged in the light source 10a, which distance from the observing point 38 is relatively intermediate, and the diffusion plate 10b relatively intermediate. When the light source panel 10 illustrated in FIG. 4 is used, the transmission control unit 16 makes the aperture ratio of the portion of the liquid crystal panel 10f corresponding to the arrangement position of the light source 10a, which distance from the observing point 38 is relatively short, relatively small, the aperture ratio of the portion of the liquid crystal panel 10f corresponding to the arrangement position of the light source 10a, which distance from the observing point 38 is relatively long, relatively large, and the aperture ratio of the portion of the liquid crystal panel 10f corresponding to the arrangement position of the light source 10a, which distance from the observing point 38 is relatively intermediate, to a relatively intermediate size. Thus, as illustrated in FIG. 20, the virtual image 31 can be gradually changed from the dim blurred state to the clear state from the position where the distance from the observing point 38 is short towards the position where the distance is long.

### 2. Operation

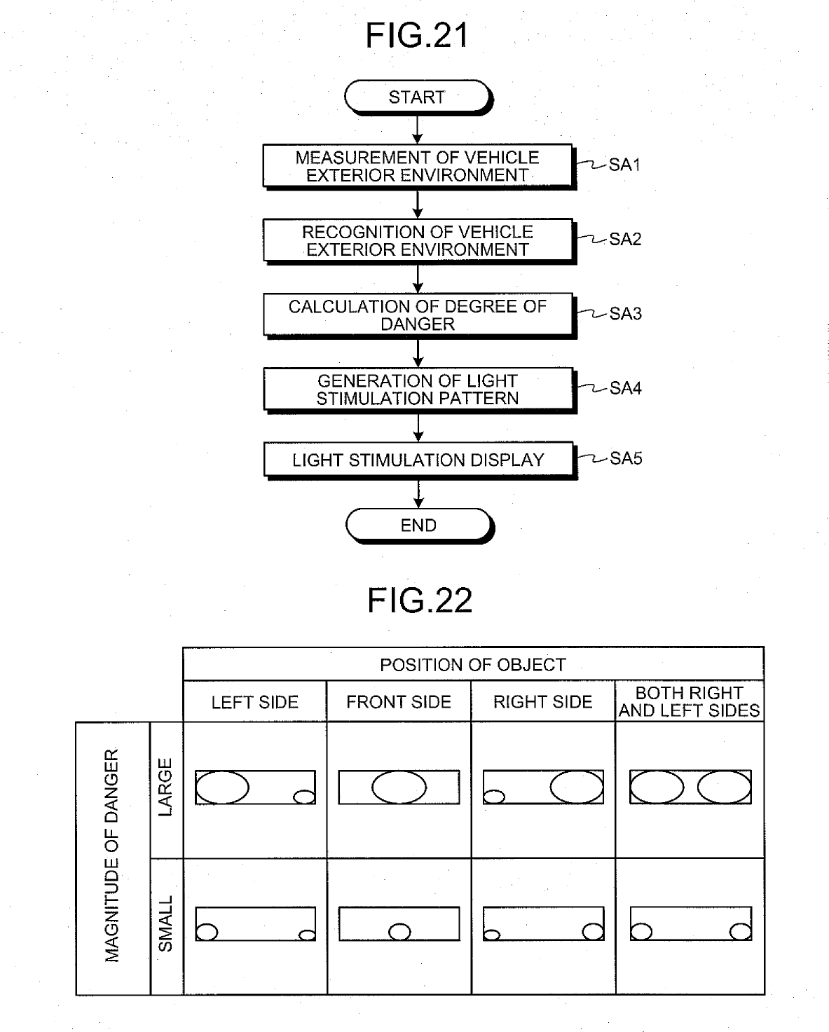

FIG. 21 is a flowchart illustrating an example of a risk calculating operation and a lighting control operation executed with the vehicle information transmitting system according to the present embodiment.

[Step SA1: Measurement of Vehicle Exterior Environment]

The object sensor 11 measures information associated with the object (e.g., pedestrian, bicycle, automobile, blind angle, etc.) around the vehicle 1.

[Step SA2: Recognition of Vehicle Exterior Environment]

The risk calculating unit 14a recognizes whether the state around the vehicle 1 is a normal state in which the object does not exist and there is no need to attract attention or warn, or a state in which the object exists and there is need to attract attention or warn based on the information associated with the object measured in step SA1. For example, the risk calculating unit 14a recognizes as the normal state if the object does not exist, and recognizes as the state in which there is need to attract attention or warn if the object exists.

[Step SA3: Calculation of Degree of Danger]

If it is recognized that the state around the vehicle 1 is the state in which there is need to attract attention or warn in step SA2, the risk calculating unit 14a checks the existing position of the object based on the information associated with the object measured in step SA1. The risk calculating unit 14a estimates that the degree of danger is small (state in which there is need to attract attention) for the object of which existing position cannot be confirmed.

The risk calculating unit 14a calculates the distance between the object and the vehicle a, and the relative deceleration (may be relative speed or relative acceleration) of the object with respect to the vehicle 1 for the object of which existing position is confirmed. The risk calculating unit 14a estimates that the degree of danger is large (state in which there is need to warn) if the distance is short, and estimates that the degree of danger is small (state in which there is need to attract attention) if the distance is long. The risk calculating unit 14a estimates that the degree of danger is small (state in which there is need to attract attention) if the relative deceleration of the object with respect to the vehicle 1 is small, and estimates that the degree of danger is large (state in which there is need to warn) if the relative deceleration is large.

[Step SA4: Generation of Light Stimulation Pattern]

The lighting control unit 15 refers to a map illustrated in FIG. 22 defining the position of the object and the degree of danger, and the irradiation position and the irradiation area of the light based on the existing position of the object confirmed in step SA3 and the degree of danger of the object estimated in step SA3 to determine the irradiation position (irradiation position in the horizontal direction and the vertical (height) direction) and the irradiation area of the light for notification, and to determine the irradiation position and the irradiation area of the light for allocating attention, as needed. For example, the irradiation position of the light for notification is set to the left side if the existing position of the object is on the left side, the front side if on the front side, and the right side if on the right side. The irradiation position of the light for allocating attention is set to the right side if the irradiation position of the light for notification is on the left side, the left side if on the right side, and is not set if on the front side or on both right and left sides. The irradiation area of the light for notification is set large at the time of warning in which the degree of danger of the object is large, and is set small at the time of attracting attention in which the degree of danger of the object is small. The irradiation area of the light for allocating attention is set small to an extent the difference from the irradiation area of the light for notification is clear at the time of warning in which the degree of danger of the object is large, and is set small in some measure to an extent that there is barely any difference from the irradiation area of the light for notification at the time of attracting attention in which the degree of danger of the object is small.

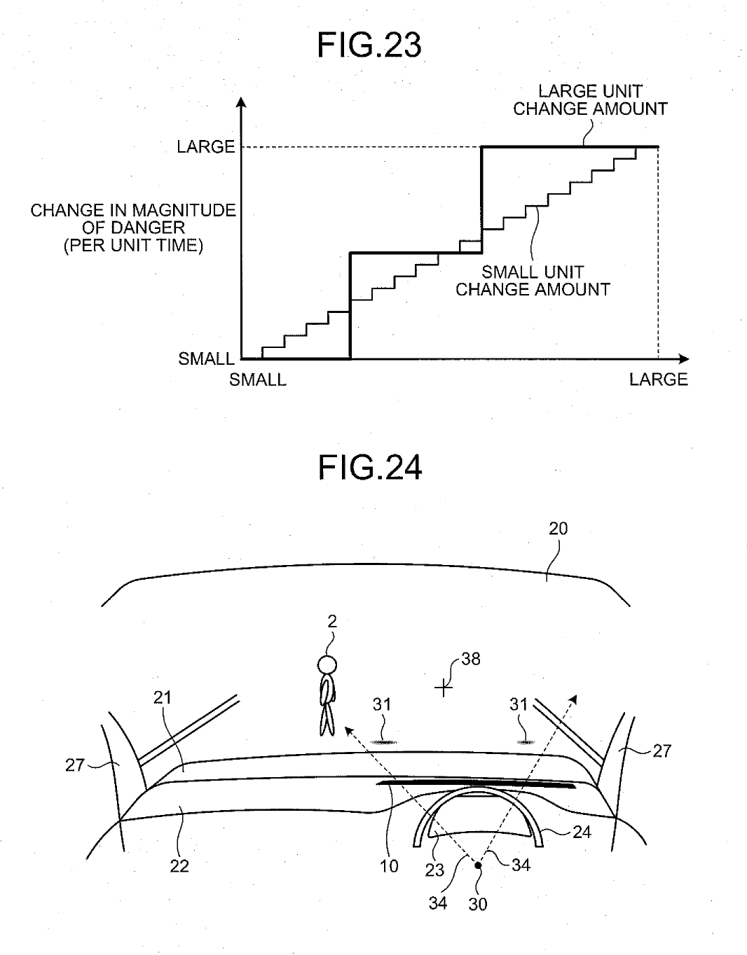

The lighting control unit 15 determines the color/luminance of the light for notification, and determines the color/luminance of the light for allocating attention, which is different from the color/luminance of the light for notification, based on the degree of danger of the object estimated in step SA3, and the state of color/luminance adjusted and stored in advance according to the maps illustrated in FIG. 12 and FIG. 13. The lighting control unit 15 determines a variation per unit change (variation per unit) of the color/luminance of the light for notification based on the degree of danger of the object estimated in step SA3. For example, as illustrated in FIG. 23, the variation per unit of the color/luminance is set large when the change per unit time of the degree of danger is large, and the variation per unit of the color and the luminance is set small when the change per unit time of the degree of danger is small.

The lighting control unit 15 generates the lighting pattern for notification (for attracting attention or for warning) including the irradiation position, irradiation area, color, luminance, and variation per unit of the light determined as above. If it is recognized in step SA2 that the state around the vehicle 1 is a normal state in which there is no need to attract attention, the lighting control unit 15 generates the lighting pattern for regular-time, which is different from the lighting pattern for notification, including the color and luminance of the light for regular-time based on the state of the color/luminance adjusted and stored in advance according to the maps illustrated in FIG. 12 and FIG. 13.

[Step SA5: Light Stimulation Display]

The lighting control unit 15 sets (corrects) the center position at the time of lighting in the light source panel 10 according to the road shape, and executes the lighting control of the individual light source 10a to obtain the relevant lighting pattern based on the lighting pattern for notification or for regular-time generated in step SA4 and the set center position.

According to the risk calculating operation and the lighting control operation described above, under a situation illustrated in FIG. 24 where warning is necessary (e.g., situation in which an object 2 with a large degree of danger exists on the left side when seen from the driver), the virtual image 31 for notification set according to the degree of danger of the object 2 is appeared in the left direction. A dummy virtual image 31 for allocating attention, which is set so that the total attention allocation of the driver to surroundings of the vehicle 1 is set to become constant, is also appeared in the right direction set so that the total becomes constant. Whereby, the attention of the driver to the surroundings of the vehicle 1 can be maintained uniform (uniformed) in such situation.

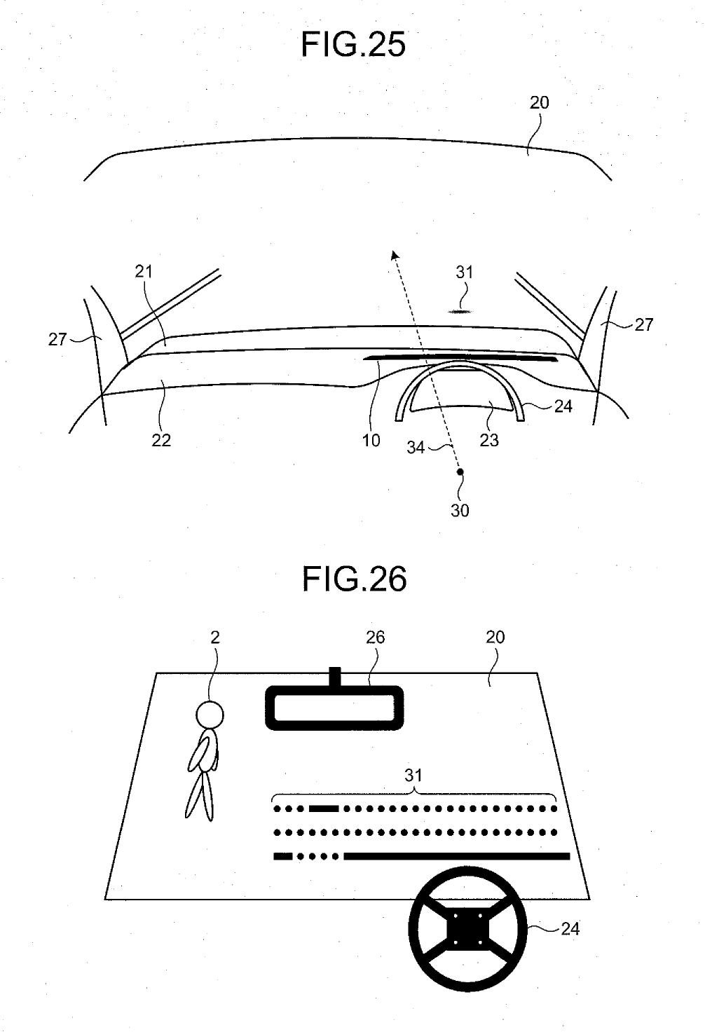

According to the risk calculating operation and the lighting control operation described above, under a normal (safe) situation (e.g., situation in which the object does not exist around the vehicle 1) illustrated in FIG. 25 where there is no need to attract attention or warn, the virtual image 31 for regular-time, which is different from that for notification and in which the tone is lowered, is appeared in the left direction, center (front side) direction, right direction, or entirely when seen from the driver, for example. In a case illustrated in FIG. 26 in which the situation changes from the normal situation to the situation in which the object 2 has appeared and the warning is now necessary, the lighting state of the portion (lowermost layer, portion on the left side in FIG. 26) corresponding to the existing position or the existing direction of the object 2 of the green virtual image 31 for regular-time lighting at the lowermost layer is weakened. Meanwhile, the lighting state of the relevant portion (uppermost layer, portion on the left side in FIG. 26) of the red virtual image for warning at the uppermost layer is strengthened. Thus, when the situation changes from the normal situation to the situation in which there is need to attract attention or warn, the attention attracting and the warning can be naturally prompted to the driver without a sense of discomfort and without unexpectedness.

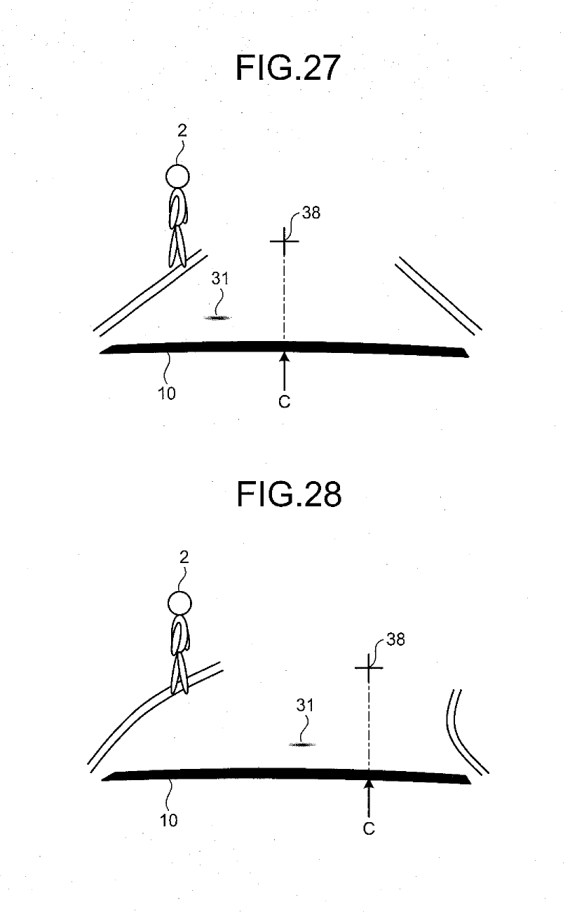

According to the risk calculating operation and the lighting control operation described above, the center position C at the time of lighting is set (corrected) to the middle (front side) when seen from the driver in accordance with the road shape in the case illustrated in FIG. 27 in which the vehicle 1 is travelling a straight road under a situation where the notification is necessary, the center position C at the time of lighting is set (corrected) to the right side when seen from the driver in accordance with the road shape in the case illustrated in FIG. 28 in which the vehicle 1 is travelling a road of right curve, and the virtual image 31 for notification is appeared based on the setting of the center position C. Thus, the attention attracting or warning can be prompted to the driver in a range not deviating from the viewing field of the driver (constant range from the observing direction of the driver).

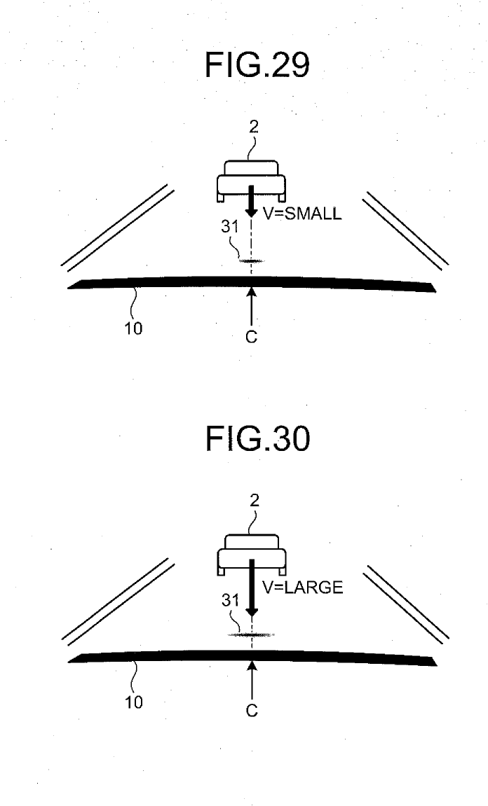

According to the risk calculating operation and the lighting control operation, the virtual image 31 for attracting attention in which the variation per unit is set small is appeared under a situation illustrated in FIG. 29 in which the relative deceleration V of the object 2, which is a preceding vehicle, is small and attention needs to be sought. The virtual image 31 for warning in which the variation per unit is set large is appeared under a situation illustrated in FIG. 30 in which the relative deceleration V of the object 2 is large and warning is necessary. Thus, the attention attracting or warning can be prompted to the driver with the lighting content complying with the relative relationship of the vehicle 1 and the object.

### 3. Conclusion of Present Embodiment

According to the present embodiment, the attention attracting or warning is prompted to the driver by irradiating the light of a plurality of light sources 10a arranged in an array form (plural rows or plural columns) in the light source panel 10 mounted at a predetermined position of the instrument panel 22 with the color, luminance, area, cycle, and the like corresponding to the degree of danger, and the like of the dangerous object to the portion of the front window glass 20 corresponding to the existing position or the existing direction of the dangerous object (e.g., pedestrian, bicycle, automobile, blind angle, etc.). In the conventional night view system, for example, when a human is detected with an infrared sensor at night, this is notified with the detected human surrounded with a frame, but the correspondence relationship of what is displayed on the screen and the actual situation is difficult for the driver to understand. However, according to the present embodiment, having the position or direction of the dangerous object to be easily and reliably noticed by (notified to) the driver, and notifying so as not to be bothersome and not to provide discomfort to the driver can both be achieved.

According to the present embodiment, the luminance (application voltage) and the color of the light of each light source 10a are set according to the distance from the arrangement position of the light source 10a to the irradiation position of the light from the light source 10a in the front window glass 20 and/or the angle formed by the line segment connecting the arrangement position and the irradiation position and the front window glass 20. For example, the luminance of the light is set larger for the light source 10a having a larger distance from the irradiation position is longer. Thus, the light reflected by the vehicle body is more easily visually perceive by the driver, and consequently, the transmission efficiency of the information can be enhanced. The light can be focused on a position that is easy to see in accordance with the eye point of the driver.

According to the present embodiment, the light source panel 10 includes a mechanism for adjusting the luminance of the light from the light source 10a (transmitting extent or blurring extent (blurring degree) of light). Thus, bothersome that occurs when the light is strong can be resolved. For example, the luminance of the light is lowered to blur the virtual image when prompting the driver to check a certain position or direction, and the luminance of the light is raised to have the virtual image appear clearly when transmitting specific information such as character, icon, and the like. Thus, it becomes more difficult for the driver to focus on the virtual image, and the foreground becomes easier to see. In transmitting the specific information, the luminance of the light is lowered to blur the virtual image when the vehicle 1 is travelling at a speed exceeding a predetermined speed. Thus, the visual performance by central vision is induced to present detailed information while parking, and the visual performance by peripheral vision is induced to transmit only the existence and the position of danger during travelling. That is, the amount and quality of the information to be transmitted can be enhanced during parking, and the amount and quality of the information to be transmitted can be suppressed during travelling. The luminance of the light is selectively lowered by the light source 10a corresponding to the irradiation position of the light perceive by the driver to partially blur the virtual image. Thus, it becomes difficult for the driver to focus on the virtual image that the driver once saw, and the viewpoint retaining time by direct vision can be reduced. The luminance of the light is raised as the quality and the priority of the information to be transmitted, such as the higher degree of danger around the vehicle 1, becomes higher to clearly show the virtual image. The important information thus can be reliably transmitted to the driver. The viewing direction that the driver needs to pay attention to the most is estimated from the road shape (curve), and the luminance of the light irradiated in such direction is lowered to blur the virtual image. Thus, while travelling the curve, it becomes difficult to focus on the virtual image in the observing direction, and the foreground becomes easier to see. The luminance of the light is adjusted to change the blurring degree of the virtual image according to the farness and closeness from and to the center view. Thus, the amount and quality of the information to be transmitted can be made appropriate in view of the human property in which a more definite shape is more easily captured when closer to the center vision.

According to the present embodiment, when notifying the existing position or the existing direction of the object, the virtual image for notification corresponding to the degree of danger, and the like of the object is appeared in the existing position or the existing direction. The virtual image for attention allocation different from the virtual image for notification is also appeared in the position or the direction different from the existing position or the existing direction. For example, when the dangerous object is on the left side or the right side, the allocation of the lighting content is modified (changed) according to the degree of danger. Thus, the attention allocation of the driver to the surroundings of the vehicle 1 can be maintained to the same extent as the regular-time while appropriately prompting the driver to check the object. Each lighting state can be changed according to the content of each danger at the time of plural simultaneous lighting. The recognition is prompted to the driver not integrally but with respect to each discontinuously discrete position. Thus, the attention allocation can be suitably carried out to the area to be recognized while prompting the perception of a wide range. When notifying the information of high urgency, the virtual image for notification corresponding to such information may be appeared temporally earlier than the virtual image for attention allocation.

According to the present embodiment, the light source 10a on the left side, the middle, or the right side on the front side of the vehicle is regular-time lighted with the lighting content for regular-time even in the normal state. Thus, when changed to the notifying state from the normal state, the attention attracting or warning can be prompted to the driver without giving a sense of discomfort and without the light standing out in excess.

According to the present embodiment, the step-wise roughness of the change in the color/luminance of the light is changed according to the change in the degree of danger around the vehicle 1. For example, the light in which the variation of the luminance and/or color per unit change is large, that is, in which the change is rough, is irradiated when the change in the degree of danger around the vehicle 1 is large. Meanwhile, the light in which the variation of the luminance and/or color per unit change is small, that is, in which the change is fine, is irradiated when the change in the degree of danger is small. In other words, the variation of the luminance and/or color of the light is changed according to the relative relationship with danger. Thus, the change in the degree of danger can be clearly transmitted to the driver by changing the way of feeling danger. The step-wise roughness of the change in the color/luminance of the light is changed according to the priority of the information to be transmitted. For example, the light in which the variation of the luminance and/or color per unit change is large, that is, in which the change is rough, is irradiated when transmitting the information of high priority. The light in which the variation of the luminance and/or color per unit change is small, that is, in which the change is fine, is irradiated when transmitting the information of low priority. Thus, the importance of the information can be clearly transmitted to the driver.

### INDUSTRIAL APPLICABILITY

Therefore, the vehicle information transmitting device according to the present invention is useful in an automobile manufacturing industry, and in particular, suited for transmitting information to a driver using a vehicle body.

### REFERENCE SIGNS LIST

10 LIGHT SOURCE PANEL
10a LIGHT SOURCE
10b DIFFUSION PLATE
10c SHAFT MEMBER
10d SPRING
11 OBJECT SENSOR
12 DRIVER SENSOR
13 VEHICLE SPEED SENSOR
14a RISK CALCULATING UNIT
15 LIGHTING CONTROL UNIT
16 TRANSMISSION CONTROL UNIT
20 FRONT WINDOW GLASS
22 INSTRUMENT PANEL
31 VIRTUAL IMAGE

1-4. (canceled)

5. A vehicle information transmitting device that transmits information in a mode involving changes, comprising:
a detecting unit configured to detect an object and information in an exterior environment surrounding an own vehicle;
a calculating unit configured to calculate a degree of danger around the own vehicle based on the object and the information detected by the detecting unit;
a light source configured to transmit an existence of a dangerous object as information to a driver based on a result calculated by the calculating unit; and
a lighting control unit configured to control a mode of lighting of the light source, wherein
the lighting control unit changes a variation amount of the mode per unit change according to a relative deceleration, a relative speed or a relative acceleration of the object detected by the detecting unit to the own vehicle.

6. The vehicle information transmitting device according to claim 5, wherein
the lighting control unit changes only the variation amount within a certain time.

7. The vehicle information transmitting device according to claim 5, wherein
the lighting control unit makes the variation amount larger as a priority of the information to be transmitted to the driver is higher.

8. The vehicle information transmitting device according to claim 5, wherein
the lighting control unit makes the variation amount larger as the degree of danger is higher.
